(19) United States
(12) Patent Application Publication
(10) Pub. No.: US 2019/0371130 A1
(43) Pub. Date: Dec. 5, 2019

(54) SYSTEM FOR AND METHOD OF OPERATING A GAMING SYSTEM

(71) Applicant: Robert SIGAL, Ile Bizard (CA)

(72) Inventor: Robert SIGAL, Ile Bizard (CA)

(21) Appl. No.: 16/541,659

(22) Filed: Aug. 15, 2019

Related U.S. Application Data
(63) Continuation of application No. PCT/IB2018/050945, filed on Feb. 15, 2018.

(30) Foreign Application Priority Data
Feb. 15, 2017 (US) 62459287

(51) Int. Cl. G07F 17/32

(52) U.S. Cl. CPC G07F 17/3293; G07F 17/326

(57) ABSTRACT

Methods of and systems for operating a gaming system. The method comprises causing the gaming system to deal at least six cards to a plurality of players interacting with the gaming system; receiving, from each one of the plurality of players, first instructions associated with combining the at least six cards so as to generate at least three two-card hands; receiving, from each one of the plurality of players, second instructions associated with discarding at least one of the at least three two-card hands so as to generate a set of at least two two-card hands; and causing the gaming system to initiate a card game comprising a plurality of rounds, wherein each one of the players selects one two-card hand from the set of at least two two-card hands associated with the given player during at least one of the plurality of rounds.

### CROSS-REFERENCE TO RELATED APPLICATIONS

The present application is a continuation application claiming priority from International Patent Application PCT/IB2018/050945 filed on Feb. 15, 2018 which claims priority to U.S. Provisional Patent Application No. 62/459,287, filed Feb. 15, 2017, entitled “SYSTEM FOR AND METHOD OF OPERATING A GAMING SYSTEM” the entirety of which are incorporated herein by reference.

### FIELD

The present technology relates to systems and methods of operating a gaming system. In particular, the systems and methods allow causing the gaming system to deal cards, receiving instructions and initiating a card game.

### BACKGROUND

Texas Hold'em is a variation of the card game of Poker which has become very popular in the recent years. As for various card games, Texas Hold'em may be played on a live game table (such as the ones that may be found in casinos) and/or be played on electronic devices executing a set of instructions implementing partially or completely a virtual game table. According to Texas Hold'em rules, two cards, also referred to as two-card hands, hole cards or hold cards, are dealt face down to each player, and then five community cards are dealt face up, typically in three states. The stages consist of a series of three cards (“the flop”), later an additional single card (“the turn”) and a final card (“the river”). Each player seeks the best five card Poker hand from the combination of the community cards and their own hole cards. Typically, players have betting options to check, call, raise or fold. In some instances, rounds of betting take place before the flop is dealt and after each subsequent deal.

Texas Hold'em has recently increased in popularity mainly thanks to online gaming allowing a large number of players to play anonymously while betting according to their financial means. As Texas Hold'em generally requires two or more players, certain computer-based versions of the game implement virtual players also use computer heuristics to attempt to allow the virtual players to behave like actual human players.

Multiple variations of Texas Hold 'hem have been developed to increase the level of experience and engagement of the players. However, such variations may still present limits with respect to the frequency at which a player plays during a game and/or the amount of control that is provided to the player during the game.

Improvements may be therefore desirable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

Embodiments of the present technology have been developed based on developers' appreciation of shortcomings associated with the prior art.

In particular, such shortcomings may comprise (1) a period of time between two rounds of a game as a new two-card hand needs to be distributed at the beginning of each round thereby limiting the frequency at which a player plays during a game and/or (2) the amount of control that is provided to the player during the game as the player does not have control on the combination of cards that defines the two-card hand and/or control over selecting one two-card hand from a plurality of two-card hands.

In one aspect, various implementations of the present technology provide a method of operating a gaming system, the method comprising:
causing the gaming system to deal at least six cards to a plurality of players interacting with the gaming system;
receiving, from each one of the plurality of players, first instructions associated with combining the at least six cards so as to generate at least three two-card hands;
receiving, from each one of the plurality of players, second instructions associated with discarding at least one of the at least three two-card hands so as to generate a set of at least two two-card hands; and
causing the gaming system to initiate a card game comprising a plurality of rounds, wherein each one of the players selects one two-card hand from the set of at least two two-card hands associated with the given player during at least one of the plurality of rounds.

In another aspect, various implementations of the present technology provide a method of operating a gaming system, the method comprising:
dealing at least six cards to a plurality of players interacting with the gaming system;
receiving, from each one of the plurality of players, first instructions associated with combining the at least six cards so as to generate at least three two-card hands;
receiving, from each one of the plurality of players, second instructions associated with discarding at least one of the at least three two-card hands so as to generate a set of at least two two-card hands; and
initiating a card game comprising a plurality of rounds, wherein each one of the players selects one two-card hand from the set of at least two two-card hands associated with the given player during at least one of the plurality of rounds.

In another aspect, various implementations of the present technology provide a method of operating a gaming system, the method comprising:
triggering a first timer associated with a first predetermined time upon causing the gaming system to deal at least six cards to a plurality of players interacting with the gaming system;
causing the gaming system to allow each one of the plurality of players to provide first instructions to the gaming system, the first instructions being associated with combining the at least six cards so as to generate at least three two-card hands;
upon determining that the first instructions have not been provided prior to the first predetermined time for a given one of the plurality of players, causing the gaming system to automatically combine the at least six cards associated with the given one of the plurality of players so as to generate at least three two-card hands;
triggering a second timer associated with a second predetermined time;
causing the gaming system to allow each one of the plurality of players to provide second instructions to the gaming system, the second instructions being associated with discarding at least one of the at least three two-card hands so as to generate a set of at least two two-card hands;
upon determining that the second instructions have not been provided prior to the second predetermined time for a given one of the plurality of players, causing the gaming system to automatically discard at least one of the at least three two-card hands so as to generate the set of at least two two-card hands; and
causing the gaming system to initiate a card game comprising a plurality of rounds, wherein each one of the players selects one two-card hand from the set of at least two two-card hands associated with the given player during at least one of the plurality of rounds.

In other aspects, various implementations of the present technology provide a non-transitory computer-readable medium storing program instructions for operating a gaming system, the program instructions being executable by a processor of a computer-based system to carry out one or more of the above-recited methods.

In other aspects, various implementations of the present technology provide a computer-based system, such as, for example, but without being limitative, an electronic device comprising at least one processor and a memory storing program instructions for operating a gaming system, the program instructions being executable by the at least one processor of the electronic device to carry out one or more of the above-recited methods.

In the context of the present specification, unless expressly provided otherwise, a computer system may refer, but is not limited to, an “electronic device”, a “network device”, “a gaming device”, a “controller”, an “operation system”, a “system”, a “computer-based system” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a computing environment in accordance with an embodiment of the present technology;

FIG. 2 is a diagram of a networked computing environment suitable for use with some implementations of the present technology;

FIGS. 3 to 9 illustrate various states of a virtual card game table in accordance with an embodiment of the present technology;

FIG. 10 illustrates a chart listing number of cards dealt to each player, the number of cards used for the boards and the number of burns per round based on the number of players in accordance with embodiments of the present technology;

FIGS. 11-24 illustrate embodiments of a gaming application in accordance with embodiments of the present technology;

FIG. 25 is a diagram illustrating a flowchart illustrating a first computer-implemented method implementing embodiments of the present technology;

FIG. 26 is a diagram illustrating a flowchart illustrating a second computer-implemented method implementing embodiments of the present technology; and

FIG. 27 is a diagram illustrating a flowchart illustrating a third computer-implemented method implementing embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “gaming application” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” or a “gaming application” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

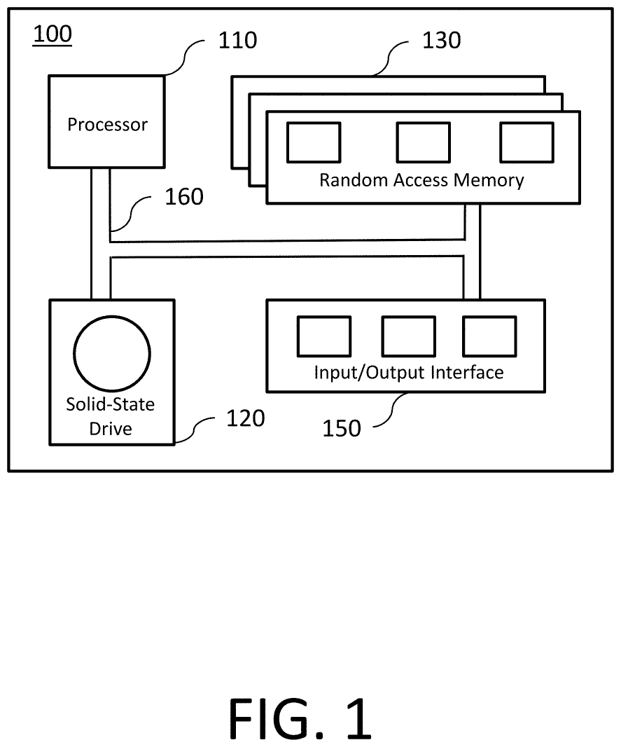

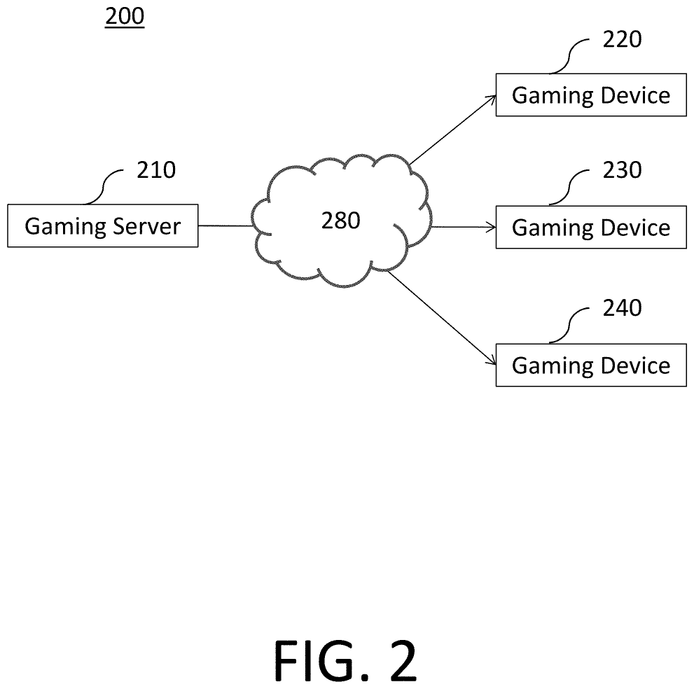

FIG. 1 illustrates a diagram of a computing environment 100 in accordance with an embodiment of the present technology. In some embodiments, the computing environment 100 may be implemented by any of the gaming devices in FIG. 2. In some embodiments, the computing environment 100 comprises various hardware components including one or more single or multi-core processors collectively represented by a processor 110, a solid-state drive 120, a random access memory 130 and an input/output interface 150. The computing environment 100 may be a computer specifically designed for gaming operations, such as, but not limited to, gaming electronic devices that may or may not connected to a network. In some alternative embodiments, the computing environment 100 may be a generic computer system. The computing environment 100 may be an “electronic device”, a “gaming device”, a “system”, a “computer-based system” and/or any combination thereof appropriate to the relevant task at hand. In some embodiments, the computing environment may include a smartphone, a phablet, a smart watch, a wearable computer, a PDA and/or a tablet on which a gaming application embodying the present technology provides the functionalities for conducting the required operations of the gaming system.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for operating a gaming system. For example, the program instructions may be part of a library or an application.

In FIG. 2, there is shown a networked computing environment 200 suitable for use with some implementations of the present technology. The networked computing environment 200 comprises a gaming server 210 and gaming devices 220, 230, 240. The gaming server 210 and the gaming devices 220, 230, 240 may each comprise hardware and/or software and/or firmware (or a combination thereof), as is known in the art, to execute operating a gaming system.

The gaming server 210 and the gaming devices 220, 230, 240 may be coupled to a communications network 280 via communication links. In some non-limiting embodiments of the present technology, the communications network 280 can be implemented as the Internet. In other embodiments of the present technology, the communications network 280 can be implemented differently, such as any wide-area communications network (WAN), local-area communications network (LAN), a private communications network or combinations thereof.

How the communication links of the communications network 280 are implemented is not particularly limited. Merely as an example and not as a limitation, the communication links can be either wireless (such as the Wireless Fidelity, or WiFi® for short, Bluetooth® or the like) or wired (such as an Ethernet based connection).

It should be expressly understood that implementations for the gaming server 210 and the gaming devices 220, 230, 240 are provided for illustration purposes only. As such, those skilled in the art will easily appreciate other specific implementational details for the gaming devices 220, 230, 240.

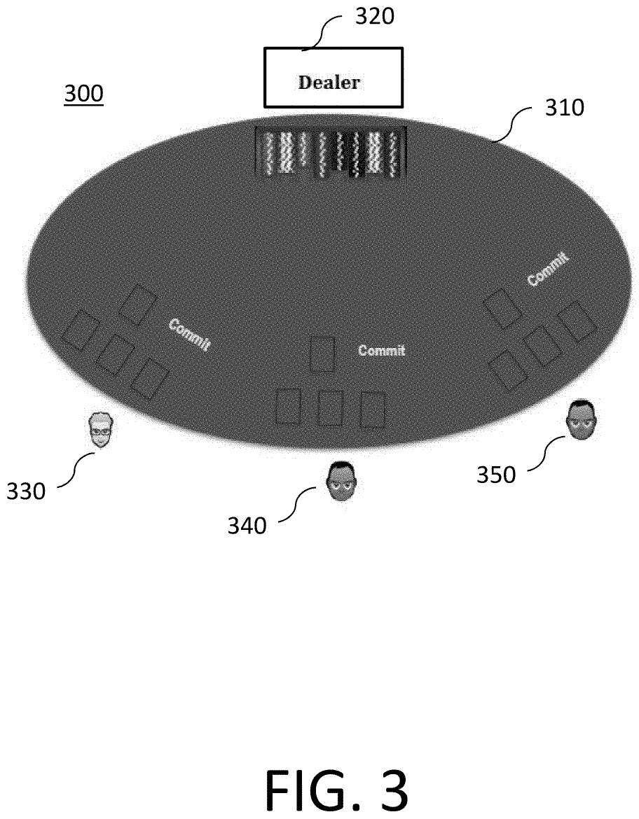

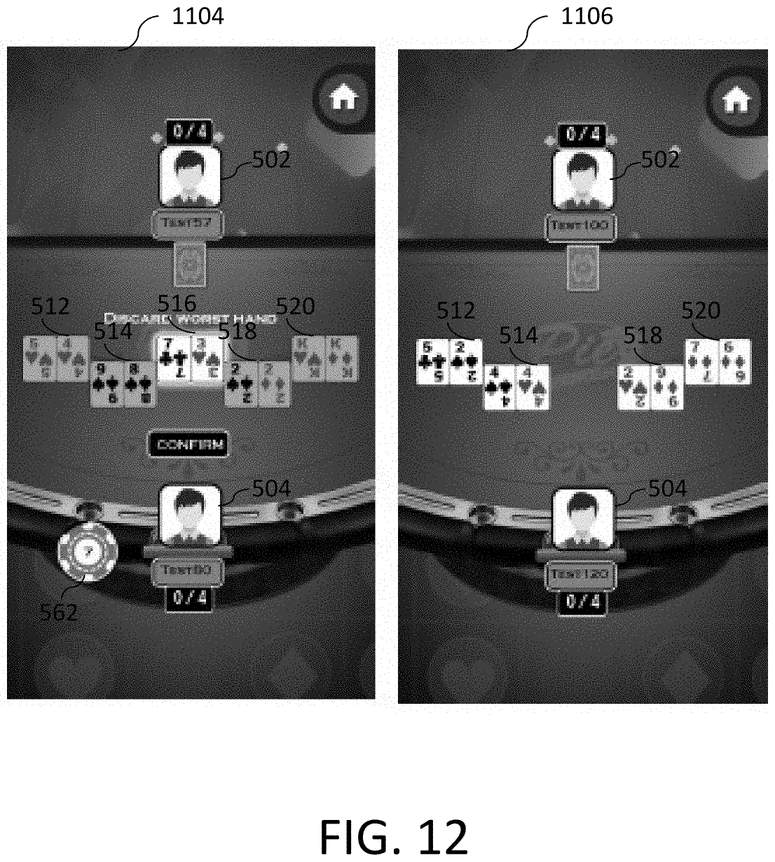

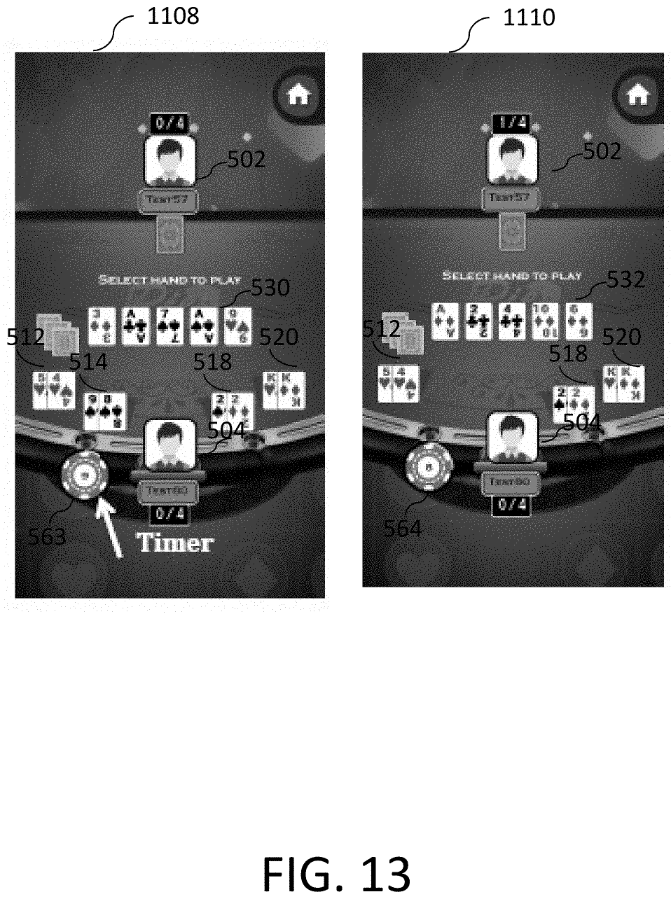

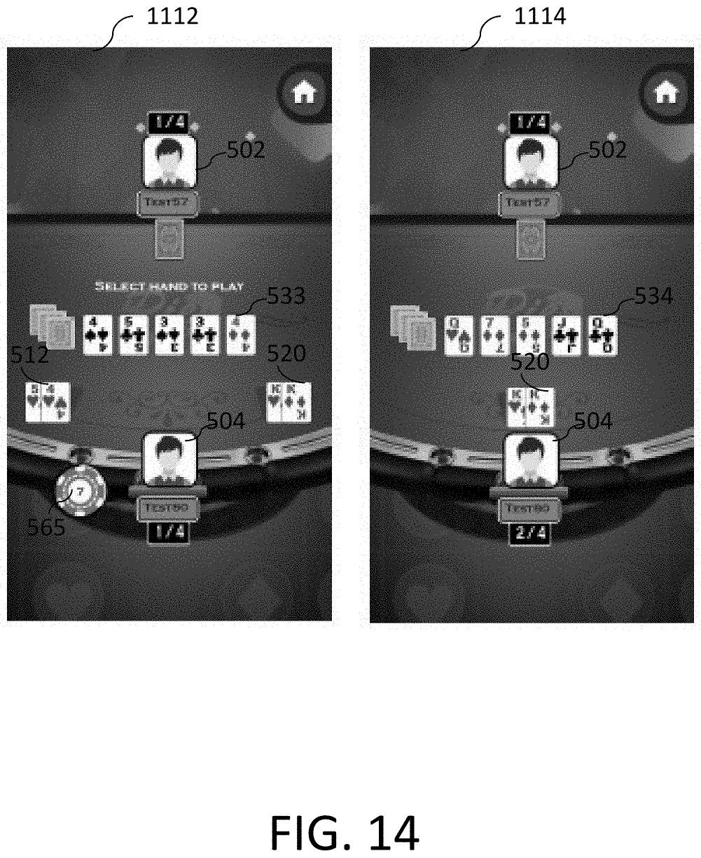

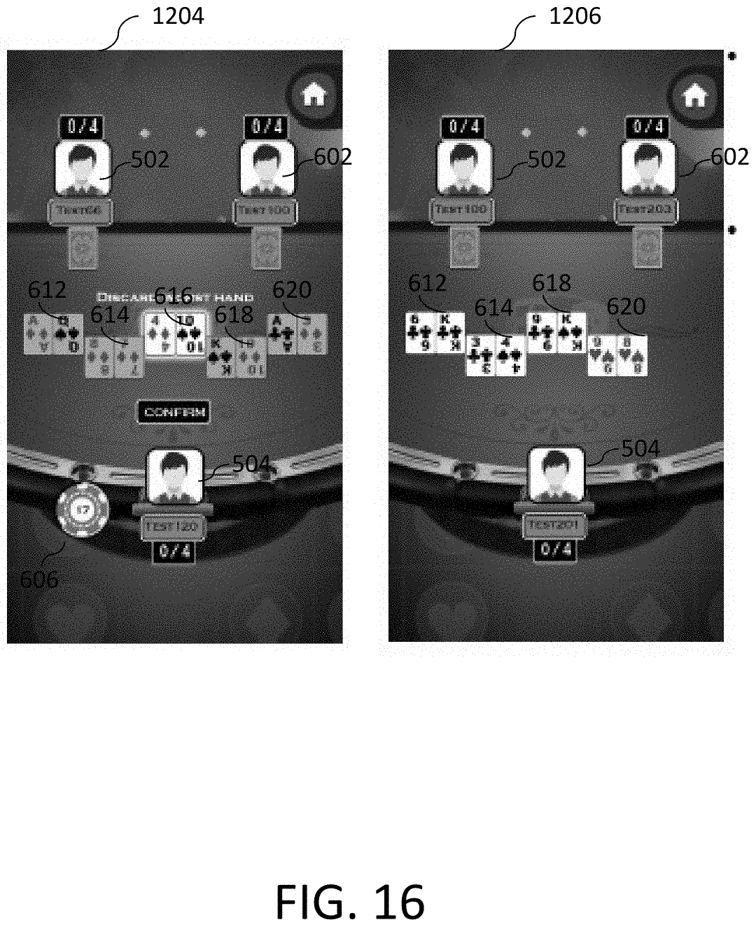

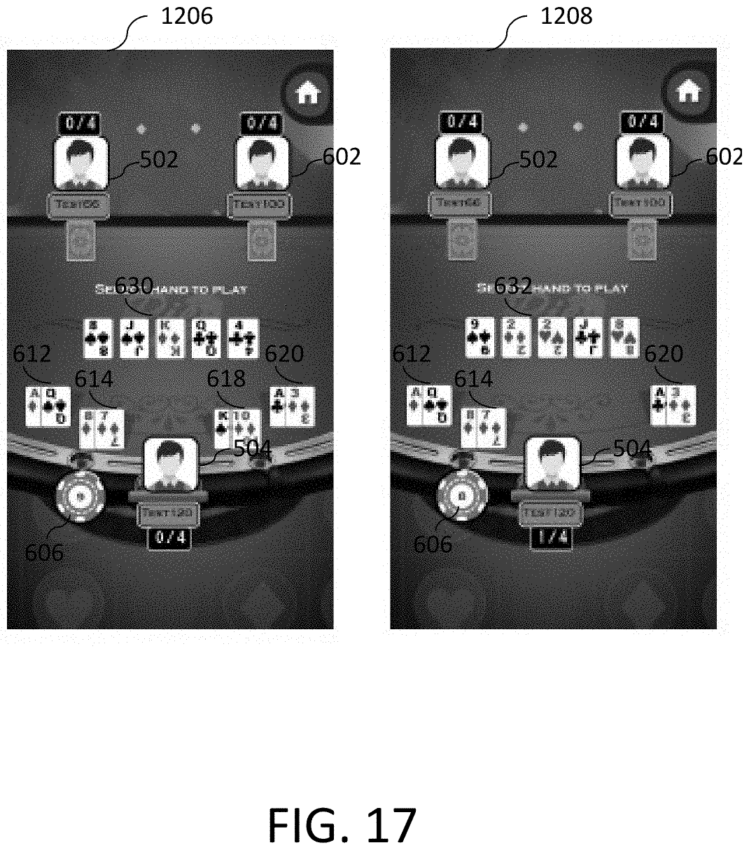

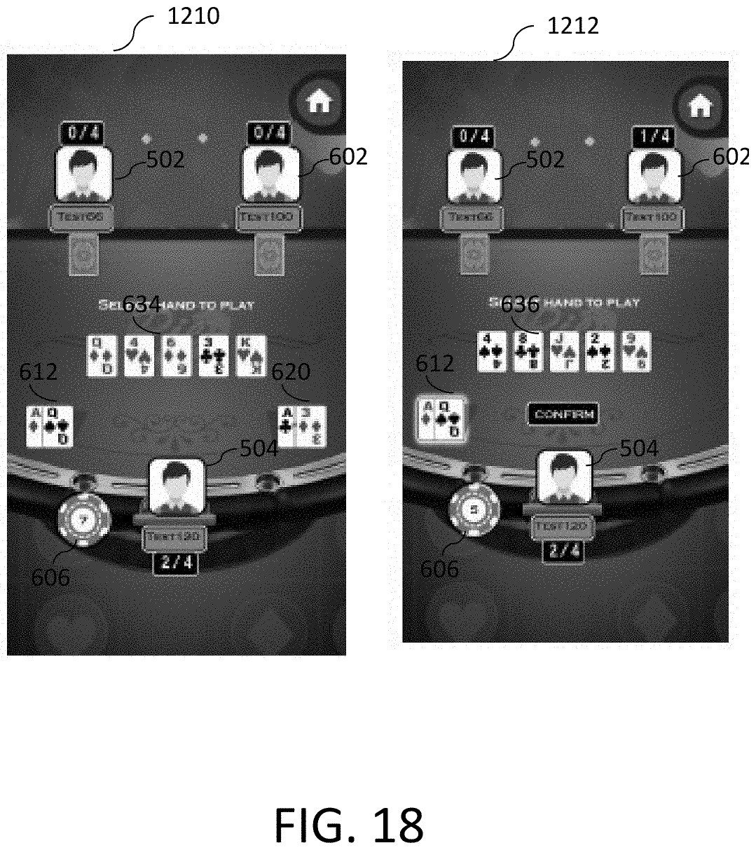

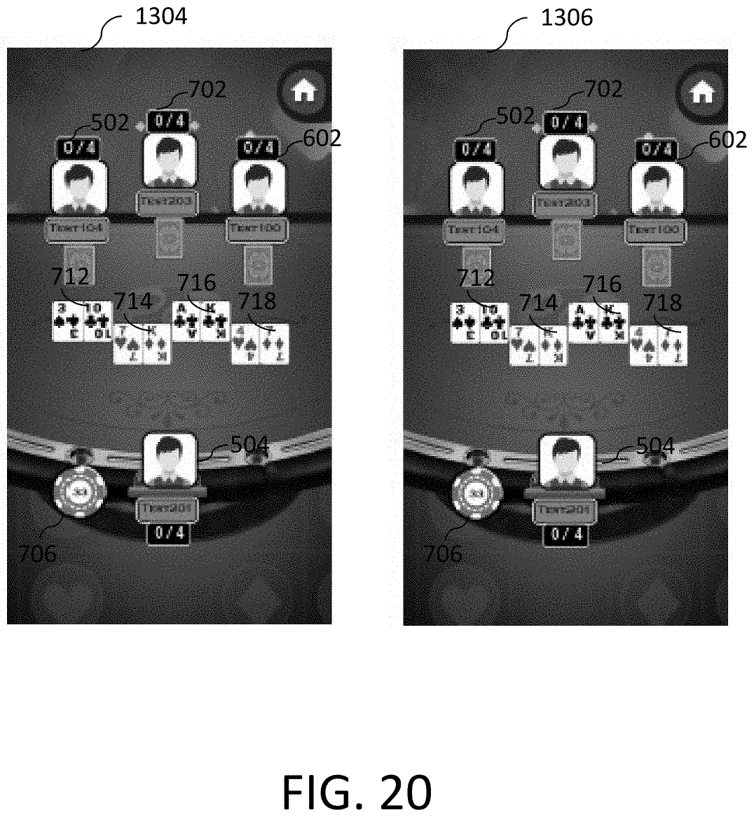

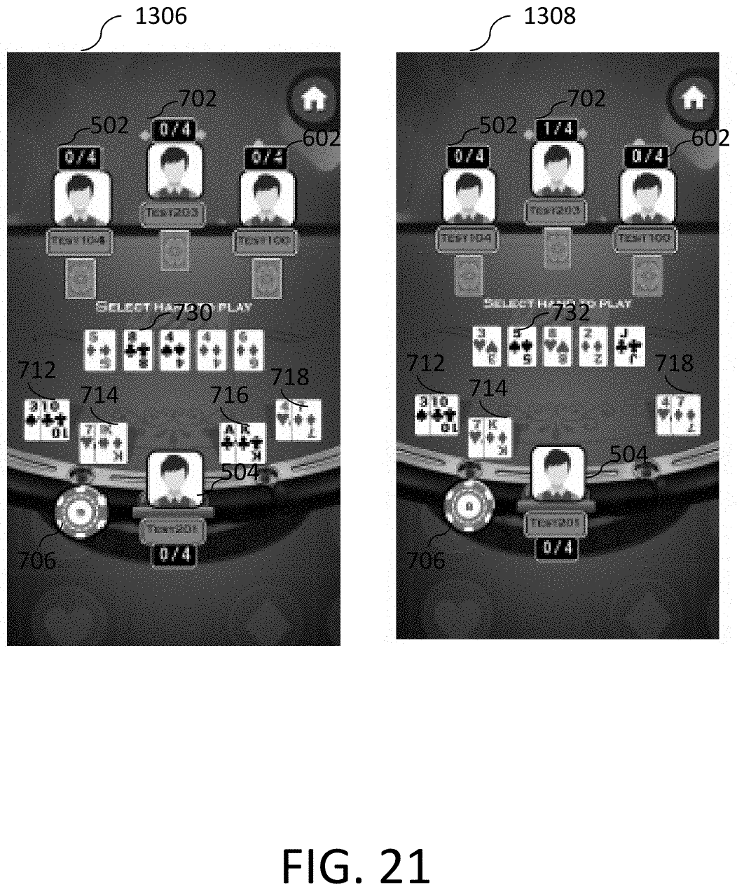

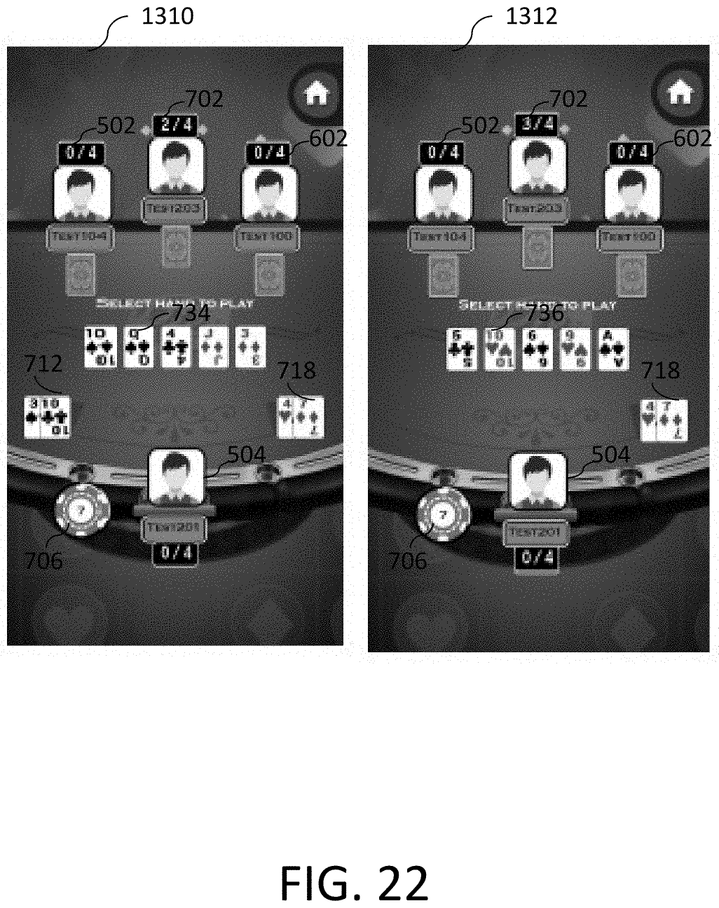

As it may be appreciated, in some non-limitative embodiments, the gaming server 210 and/or the gaming devices 220, 230, 240 may comprise a gaming application allowing users to interact with a real and/or a virtual card game in accordance with the functionalities to be further detailed in connection with the description of FIG. 3-24. The gaming application may be executed on any of the gaming server 210, the gaming devices 220, 230, 240 and/or a combination thereof. Other functions than the interaction with a real and/or a virtual card game may also be executed by the gaming application as it may become apparent to the person skilled in the art of the present technology.

Turning now to FIG. 3, an example of a card game executed in accordance with an embodiment of the present technology is displayed. In the illustrated embodiment, a graphical user interface (GUI) 300 is displayed, typically on the gaming system operating the card game. In some embodiments, where the gaming system is embodied by one or more of the gaming devices 220, 230, 240, the GUI 300 may be displayed on a display associated with one or more of the gaming devices 220, 230, 240. In some embodiments, interactions with the GUI 300 may be completed via a dedicated controller and/or a touch screen associated with the display of a gaming device. As the person skilled in the art of the present technology may appreciate other variations as to how interactions with the GUI 300 may be envisioned without departing from the scope of the present technology.

As it may be appreciated, the GUI 300 comprises a virtual card game table 310 which is associated with three players 330, 340, 350. Each one of the three players may be real or virtual players. Each one of the three players 330, 340, 350 may be associated with a dedicated gaming device (e.g., the player 330 may be associated with the gaming device 220, the player 340 may be associated with the gaming device 230, the player 350 may be associated with the gaming device 240). In some embodiments, multiple players may use a same gaming device to interact with the GUI 300. The GUI 300 also comprises a dealer 320 which deals cards in accordance with rules to be further detailed in the following paragraphs.

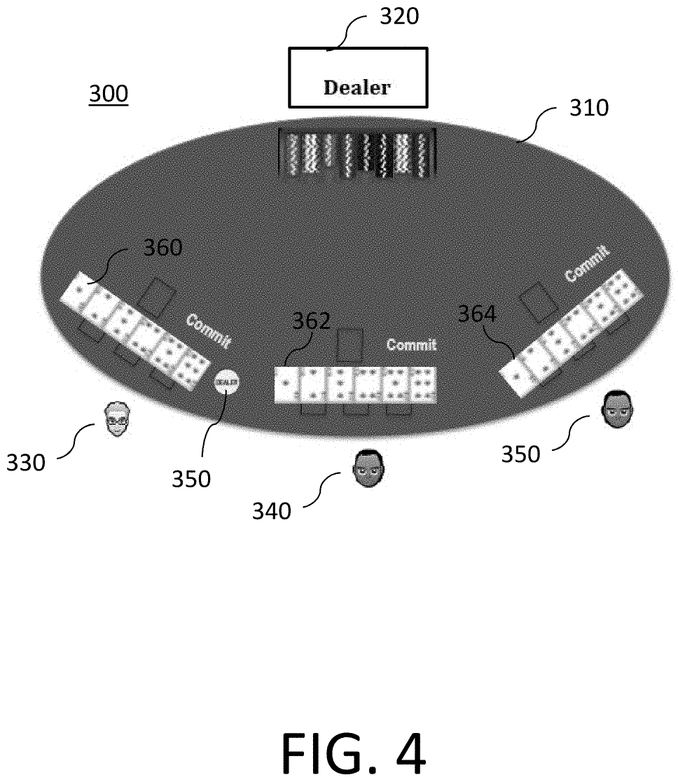

In some embodiments, operations of the gaming system executing the card game are conducted so that two (2) to six (6) players may complete a game with a deck of 52 cards. In some embodiments, the deck may be a regular deck of Poker cards. As it may be appreciated by the person skilled in the art of the present technology, the number of cards of the deck may vary and is not limited to 52 cards. In the embodiment exemplified through FIGS. 4 to 9, a game is played over two rounds. A minimum bet, which may be a mandatory ante, is to be made by each one of the players wishing to participate to a given round. In some embodiments, determination of which one of the players is to be associated with a dealer chip is made by the gaming system. The dealer chip defines an order of dealing and betting actions. In some embodiments, the determination is made by dealing one card from the deck to each one of the players. The players receiving the highest card (according to regular Poker rules) is then associated with the dealer chip. In some embodiments, dealing the cards is operated by the dealer 320 which may be embodied as a software module comprising instructions which upon being executed lead to the dealing of cards. In some other embodiments, the dealing may be executed manually.

Turning now to FIG. 4, the GUI 300 is displayed with a dealer chip 350 associated with the player 330 and cards dealt to the players 330, 340, 350. In the illustrated example, three sets of six (6) cards 360, 362, 364 have been dealt to the players 330, 340, 350 respectively. At this step, each one of the players 330, 340, 350 is prompted to combine her/his respective six (6) cards to create three (3) two-card hands. In some embodiments, a message may be displayed on the display of the gaming device associated with a given player. In some embodiments, instructions are provided by a given player via interactions with a touch screen. Other variations as to how the instructions are provided may also be envisioned without departing from the scope of the present technology. In some alternative embodiments, creation of the two-card hands may be automatically executed by the gaming system based on, for example, but without being limited to, heuristic or statistical methods.

In some embodiments, once the three (3) two-card hands have been created they cannot be modified. It should be understood that even though in the present example six (6) cards have been dealt to each one of the players 330, 340, 350 and three (3) two-card hands have been created by each one of the players 330, 340, 350, it is envisioned that multiple variations may be envisioned without departing from the scope of the present technology. For example, eight (8) or ten (10) cards may be dealt to each one of the players 330, 340, 350 and four (4) or five (5) two-card hands may be created by each one of the players 330, 340, 350. Other variations are also possible.

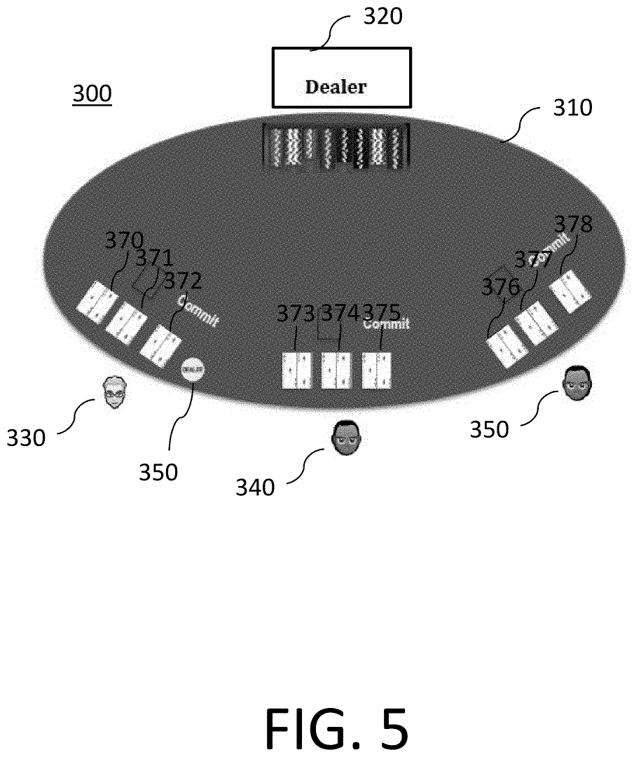

FIG. 5 illustrates two-card hands 370, 371, 372, 373, 374, 375, 376, 377, 378 having been created. The two-cards hands 370, 371, 372 are associated with the player 330, the two-card hands 373, 374, 375 are associated with the player 340 and the two-card hands 376, 377, 378 are associated with the player 350. At this step, each one of the players 330, 340, 350 is prompted to discard at least one of the two-card hands that she/he has created. In some embodiments, a message may be displayed on the display of the gaming device associated with a given player. In some embodiments, instructions are provided by a given player via interactions with a touch screen. Other variations as to how the instructions are provided may also be envisioned without departing from the scope of the present technology. In some alternative embodiments, discarding the at least one of the two-card hands may be automatically executed by the gaming system based on, for example, but without being limited to, heuristic or statistical methods. In the present example, the player 330 discards the two-card hand 372, the player 340 discards the two-card hand 375 and the player 350 discards the two-card hand 376. Once this is completed, the gaming system initiates the card game which comprises multiple rounds. In some alternative embodiments, the step of discarding at least one of the two-card hands that the players have created is not mandatory and the players proceed to the beginning of the first round without discarding any of their two-card hands.

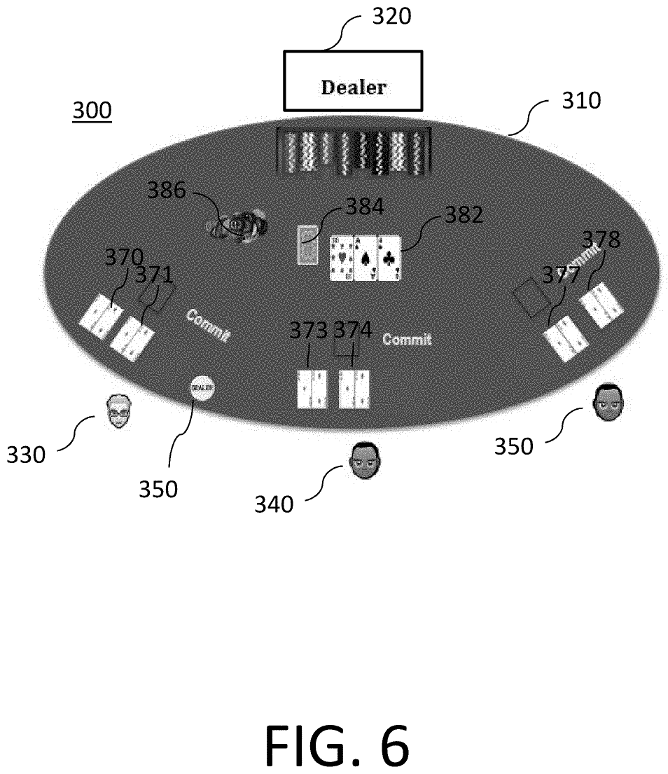

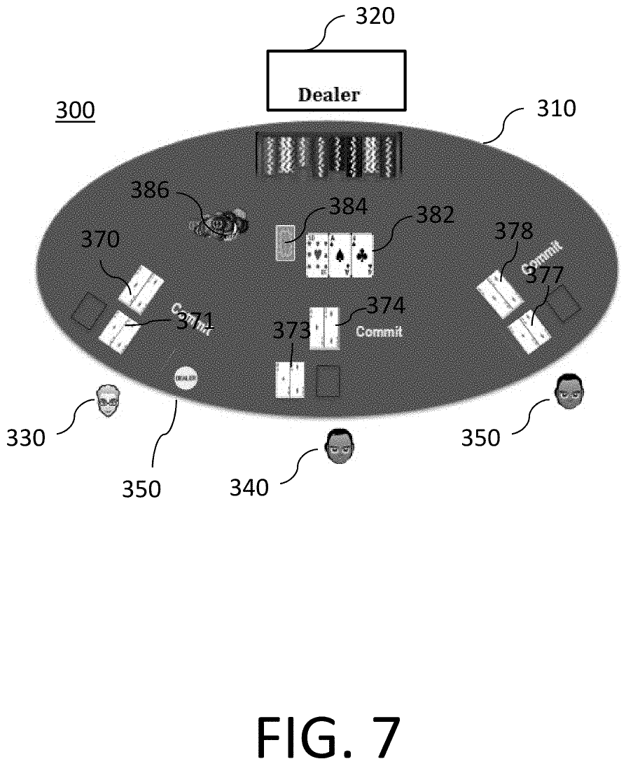

FIG. 6 illustrates the beginning of a first round wherein the players 330, 340, 350 have placed their wages for the round in a pot. A graphical representation of the pot 386 combining the wages is illustrated. House rack 382 is dealt (e.g., by the dealer 320) to create a flop which, in the present example, comprises three (3) cards. A burnt card 384 is also illustrated. As it may be appreciated from the person skilled in the art of the present technology, the number of burnt cards may vary depending on the number of players. At this step, each one of the players 330, 340, 350 is prompted to commit to one of the two-card hands of the set of two-card hands (i.e., in the present example, one of the two two-card hands) that she/he wishes to play in combination with the house rack. In some embodiments, a message may be displayed on the display of the gaming device associated with a given player. In some embodiments, instructions are provided by a given player via interactions with a touch screen. Other variations as to how the instructions are provided may also be envisioned without departing from the scope of the present technology. In some alternative embodiments, committing to the one of the two-card hands may be automatically executed by the gaming system based on, for example, but without being limited to, heuristic or statistical methods. In the present example, the player 330 commits to the two-card hand 370, the player 340 commits to the two-card hand 374 and the player 350 commits to the two-card hand 378 as illustrated in FIG. 7.

Once all players have committed, regular Poker rules (e.g., check, bet, raise, fold) commences in respect to the dealer chip. When the flop action is completed, the rake is collected and the turn is dealt as illustrated by the four cards 392.

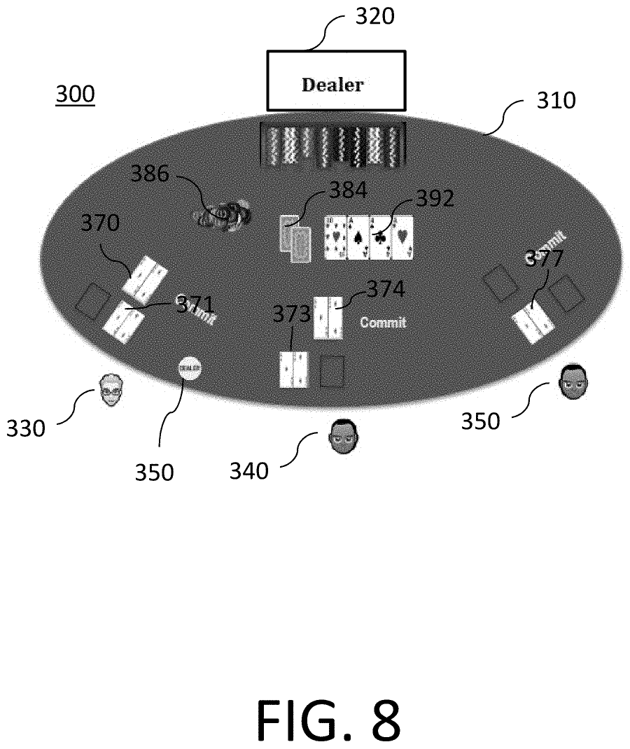

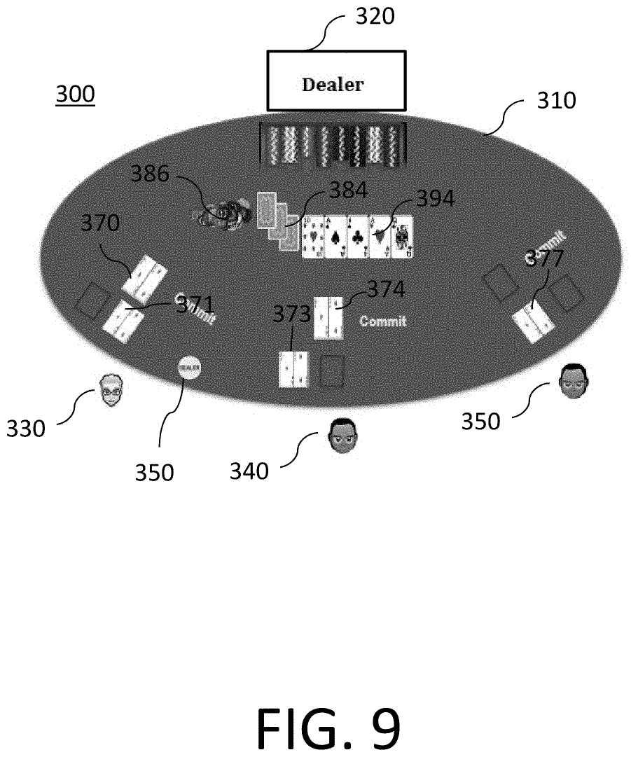

FIGS. 8 and 9 illustrates a second sequence and a third sequence of the first round which occurs after the first sequence described above. In the second sequence illustrated by FIG. 8, the player 350 has folded and the players 330 and 340 repeat the same routing as detailed above with respect to the waging. Once all the turn action is completed, the rake is collected and the river is dealt. In the third sequence illustrated by FIG. 9, the river action is played out, the rake is collected and the winner takes the pot. Subsequently, a second round begins during which players 330, 340, 350 may play their last two-card hands, two-card hands 371, 373, 377 respectively. In some embodiments, the last two-card hands are played automatically as no choices are available to the players. The second round follows a series of sequences similar to the one described with respect to the first round. In some alternative embodiments, wherein players have at least three two-card hands at the beginning of the game, a third round may be conducted. As it may become apparent to the person skilled in the art of the present technology, the number of rounds may vary depending on the number of cards of the deck, the number of players and/or the number of two-card hands associated with each one of the players.

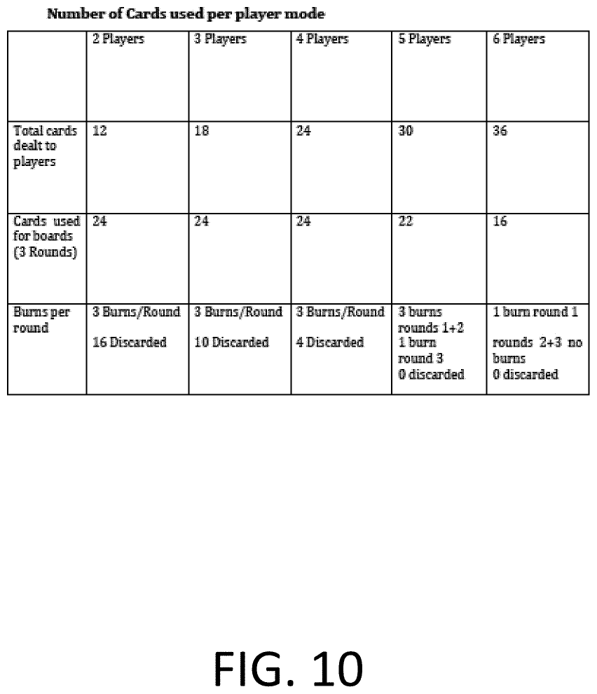

Turning now to FIG. 10, a chart listing the number of cards dealt to each player, the number of cards used for the boards and the number of burns per round based on the number of players is illustrated. As it may be appreciated by the person skilled in the art of the present technology, the chart is not to be construed as limitative but rather as exemplifying possible embodiments of the present technology.

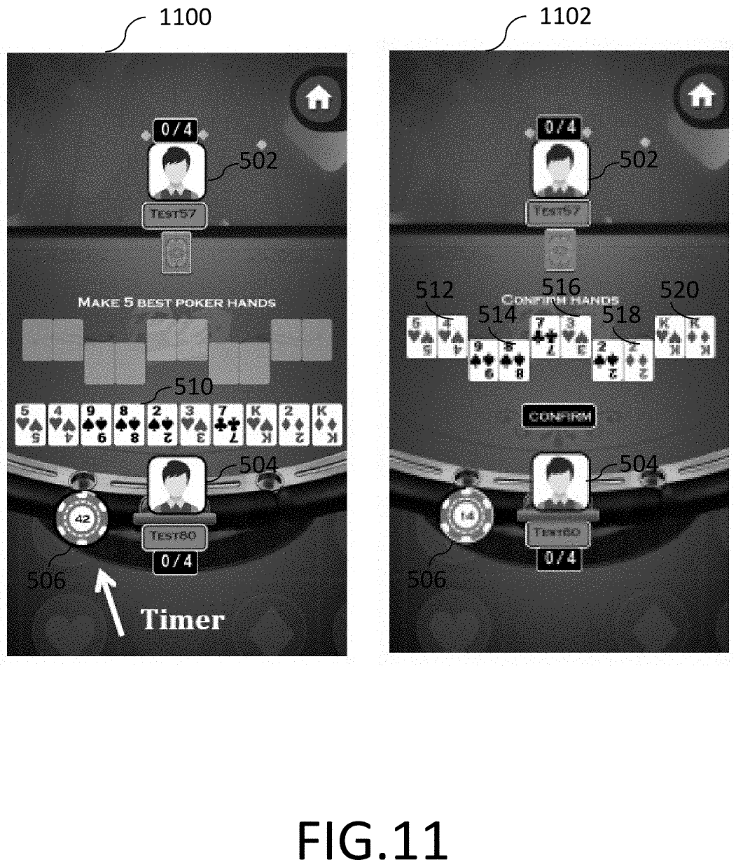

Turning now to FIG. 11-14, another embodiment of a gaming application embodying the present technology is illustrated. FIG. 11-14 illustrates a mode for two players based on a deck of 52 cards. The first screen 1100 of the gaming application illustrates a first player 502 and a second player 504. The deck of 52 cards is shuffled and then the first player 502 and the second player 504 are dealt with ten (10) cards each. In some embodiments, the sequence of dealing is as follows: the first player 502 gets a first card, the second player 504 gets a first card, the first player 502 gets a second card, the second player 504 gets a second card and so on. Once the cards are dealt, a first timer 506 is triggered. In this embodiment, the first timer 506 is associated with a first predetermined time of 45 seconds. The first player 502 and the second player 504 are prompted to provide first instructions, the first instructions being associated with combining the cards so as to generate two-card hands. In some embodiments, upon determining that the first instructions have not been provided prior to the first predetermined time for a given one of the plurality of players, the gaming system automatically combines the at least six cards associated with the given one of the plurality of players so as to generate at least three two-card hands based on, for example, but without being limited to, heuristic or statistical methods.

The second screen 1102 illustrates five (5) two card hands 512, 514, 516, 518, 520 generated by the second player 504. In the third screen 1104 the second player 504 is prompted to provide second instructions to the gaming system, the second instructions being associated with discarding at least one of the two-card hands 512, 514, 516, 518, 520 so as to generate a set of four two-card hands. In some embodiments, upon prompting the second player 504 to provide the second instructions, a second timer 562 is triggered. In the illustrated embodiment, the second timer 562 is associated with a second predetermined time of 7 seconds. Upon determining that the second instructions have not been provided prior to the second predetermined time for a given one of the plurality of players, the gaming system automatically discards at least one of two-card hands 512, 514, 516, 518, 520 so as to generate the set of at least two two-card hands based on, for example, but without being limited to, heuristic or statistical methods. In the third screen 1104, the second player 504 discards the two-card hand 516. The fourth screen 1106 illustrates the second player 504 left with 4 two-card hand. At this step, the gaming system initiates a plurality of rounds, wherein each one of the first player 502 and the second player 504 selects one two-card hand from her/his respective set of two-card hands during at least one of the plurality of rounds.

In the fifth screen 1108, a first board of cards 530 is dealt (e.g., burn, flop, burn, turn, burn, river) straight to river. In some embodiments, a third timer 563 is triggered. The third timer 563 is associated with a third predetermined time of 15 seconds. Each one of the players needs to confirm which one the four two-card hands is to be played and showdown the selected two-card hands so that determination of which one of the players has the best combination of cards according to Poker rules can be made. In some embodiments, the winner receives one point. In some embodiments, if in any round there is a “split pot” (the best 5 cards are the same for both players), each player receives 1 point for the given round. In some embodiments, upon determining that instructions have not been provided prior to the third predetermined time for a given one of the plurality of players, the gaming system automatically selects at least one of two-card hands so as to automatically play a two-card hand based on, for example, but without being limited to, heuristic or statistical methods.

The sixth screen 1110 illustrates a second round during which a second board of cards 532 is dealt. As it may be appreciated, as the two-card hand 514 has been played during the first round, the two-card hand 514 is no longer available for being played during the second round. As for the first round, a fourth timer 564 may be set. The second round is executed in a similar fashion as the first round previously described.

The seventh screen 1112 illustrates a third round during which a third board of cards 533 is dealt. As it may be appreciated, as the two-card hands 514 and 518 have been played during the first round and the second round, the two-card hands 514 and 518 are now longer available for being played during the third round. As for the first round, a fifth timer 565 may be set. The third round is executed in a similar fashion as the first round previously described.

The eighth screen 1114 illustrates a fourth round during which a fourth board of cards 534 is dealt. As it may appreciated, as the two-card hands 512, 514, 518 have been played during the first round, the second round and the third round, the two-card hands 512, 514 and 518 are no longer available for being played during the fourth round. As a result, the remaining two-card hand 520 may be automatically played.

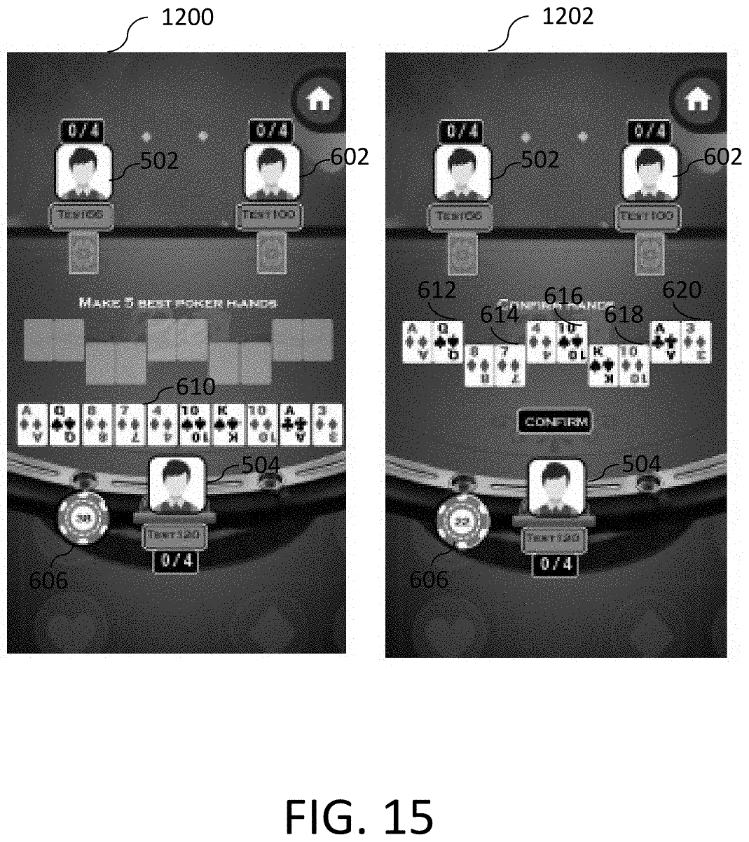

FIG. 15-18 illustrates a mode for three players based on a deck of 52 cards. Screens 1200-1212 illustrates a third player 602. In this mode, ten (10) cards 610 are dealt to each player. As for the mode illustrated at FIG. 11-14, two-card hands 612, 614, 616, 618 and 620 are created. A first board 630, a second board 632, a third board 634 and a fourth board 636 are dealt. As the number of cards needs to be managed in a way to complete four rounds with three players, no cards are burnt while dealing the first board 630, the second board 632, the third board 634 and the fourth board 636.

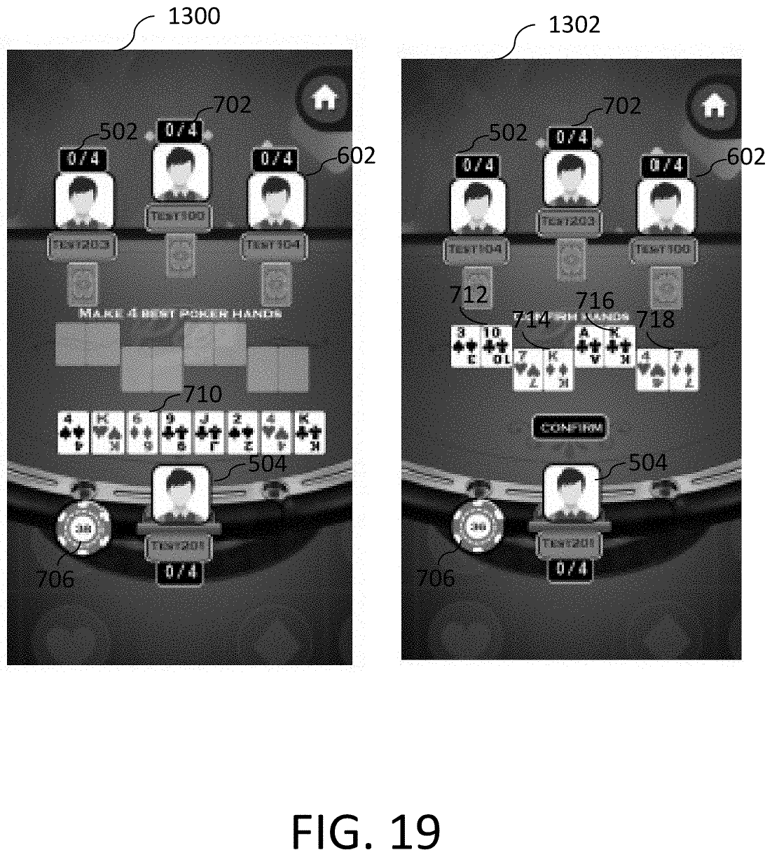

FIG. 19-22 illustrates a mode for four players based on a deck of 52 cards. Screens 1300-1312 illustrates a fourth player 702. In this mode, eight (8) cards 710 are dealt to each player. Contrary to the modes illustrated at FIG. 11-14 and FIG. 15-18, only four two-card hands 712, 714, 716 and 718 are created. As the number of cards needs to be managed in a way to complete four rounds with four players, no two-card hands are discarded in that mode. A first board 730, a second board 732, a third board 734 and a fourth board 736 are dealt. As the number of cards needs to be managed in a way to complete four rounds with four players, no cards are burnt while dealing the first board 730, the second board 732, the third board 734 and the fourth board 736.

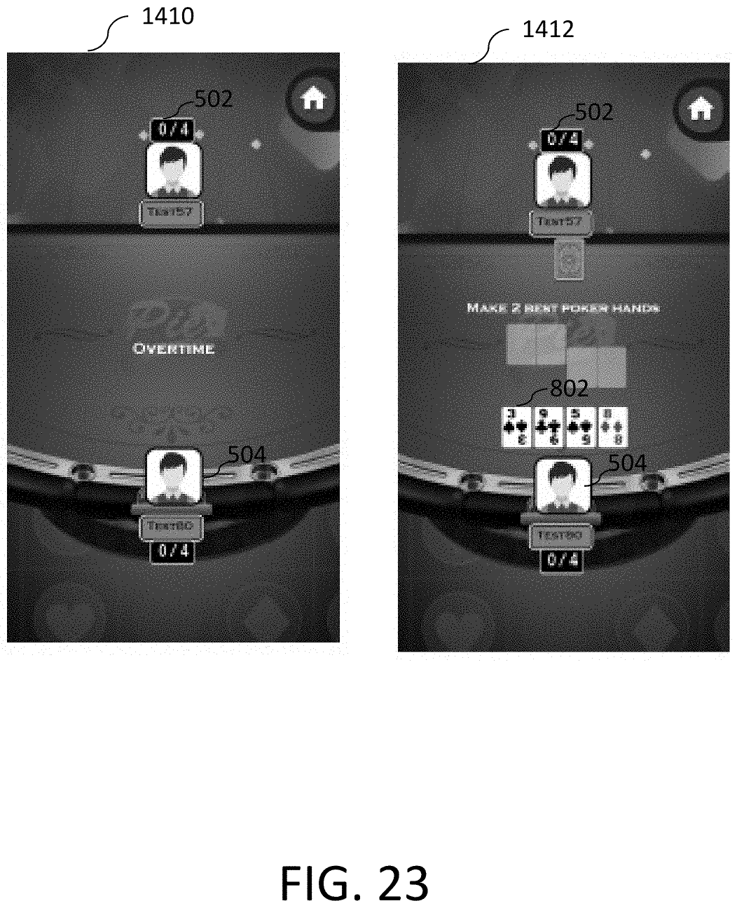

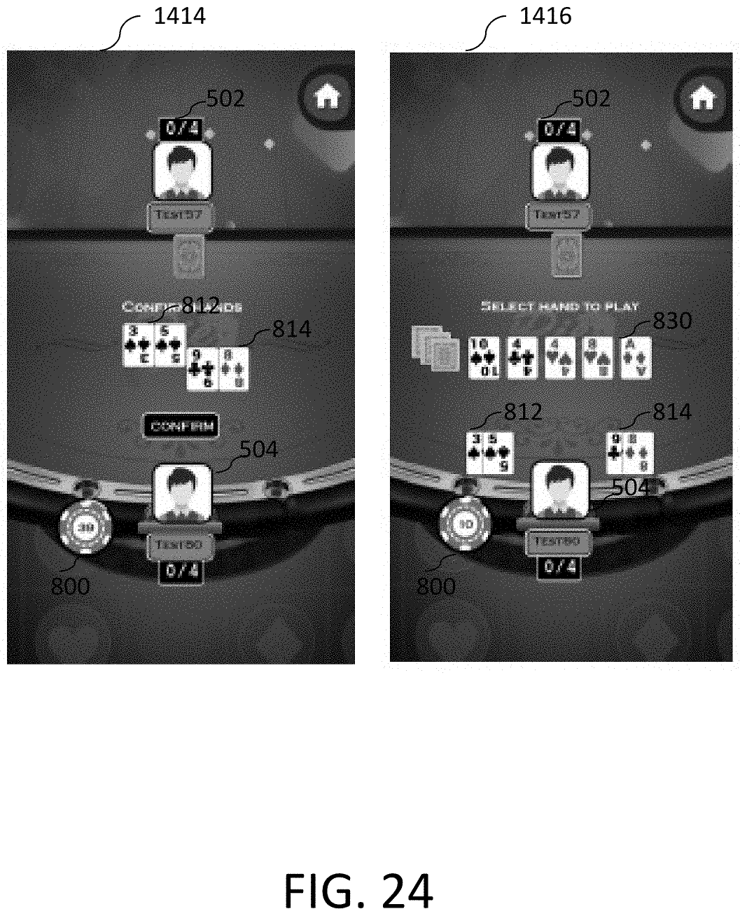

FIGS. 23 and 24 illustrates an overtime mode based on a deck of 52 cards. Screens 1410-1416 illustrates an overtime period with only one round. In this mode, four (4) cards 802 are dealt. The second player 504 creates two two-card hands 812, 814. In this mode, no two-card hands are discarded. A final board of cards 830 is dealt and each one of the first player 502 and the second player 504 selects the one of the two-card hands she/he decides to play. The overtime mode may be accessed at the end of any of the two-player mode, the three-player mode and the four-player mode. In some embodiments, the winner of the overtime mode wins the game. If there is a “split pot” in the overtime mode, a double overtime mode may occur. The deck of cards is reshuffled on a new overtime round occurs until there is a winner.

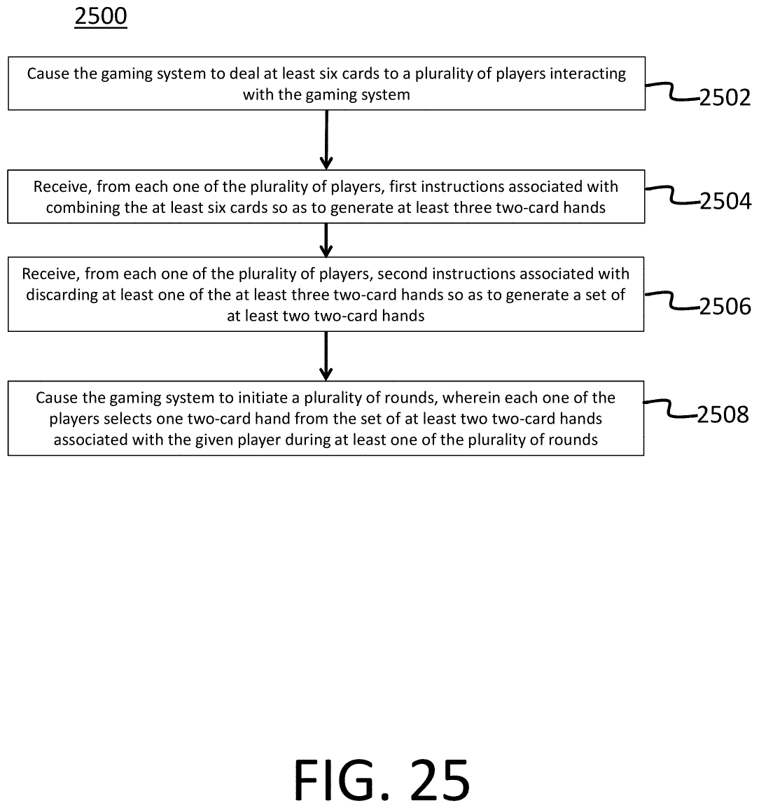

Turning now to FIG. 25, a flowchart illustrating a computer-implemented method 2500 of operating a gaming system is illustrated. In some embodiments, the computer-implemented method 2500 may be (completely or partially) implemented on a computing environment similar to the computing environment 100 and/or 200, such as, but not limited to an environment comprising a gaming server and gaming devices.

The method 2500 starts at step 2502 by causing the gaming system to deal at least six cards to a plurality of players interacting with the gaming system. Then at a step 2504, the method executes receiving, from each one of the plurality of players, first instructions associated with combining the at least six cards so as to generate at least three two-card hands. At a step 2506, the method executes receiving, from each one of the plurality of players, second instructions associated with discarding at least one of the at least three two-card hands so as to generate a set of at least two two-card hands. At a step 2508, the method executes causing the gaming system to initiate a plurality of rounds, wherein each one of the players selects one two-card hand from the set of at least two two-card hands associated with the given player during at least one of the plurality of rounds.

In some embodiments, the card game is a Poker game.

In some embodiments, the method 2500 further comprises:
causing the gaming system to deal a first board of cards; and
analyzing the selected one two-card hand of each one of the players and the first board of cards so as to determine which one of the players has a best combination of the selected one two-card hand and the first board of cards for the at least one of the plurality of rounds in accordance with Poker rules.

In some embodiments, the method 2500 further comprises:
removing the selected one two-card hand from the set of at least two two-card hands;
causing the gaming system to deal a second board of cards;
receiving, from each one of the plurality of players, third instructions associated with selecting another two-card hand from the set of at least two two-card hands; and
analyzing the other selected one two-card hand of each one of the players and the second board of cards so as to determine which one of the players has another best combination of the selected other one two-card hand and the second board of cards in accordance with the Poker rules.

In some embodiments, the first instructions associated with the given one of the plurality of players are based on a selection of a first card and of a second card from the at least six cards.

In some embodiments, the second instructions associated with the given one of the plurality of players are based on a selection of at least one of the at least three two-card hands.

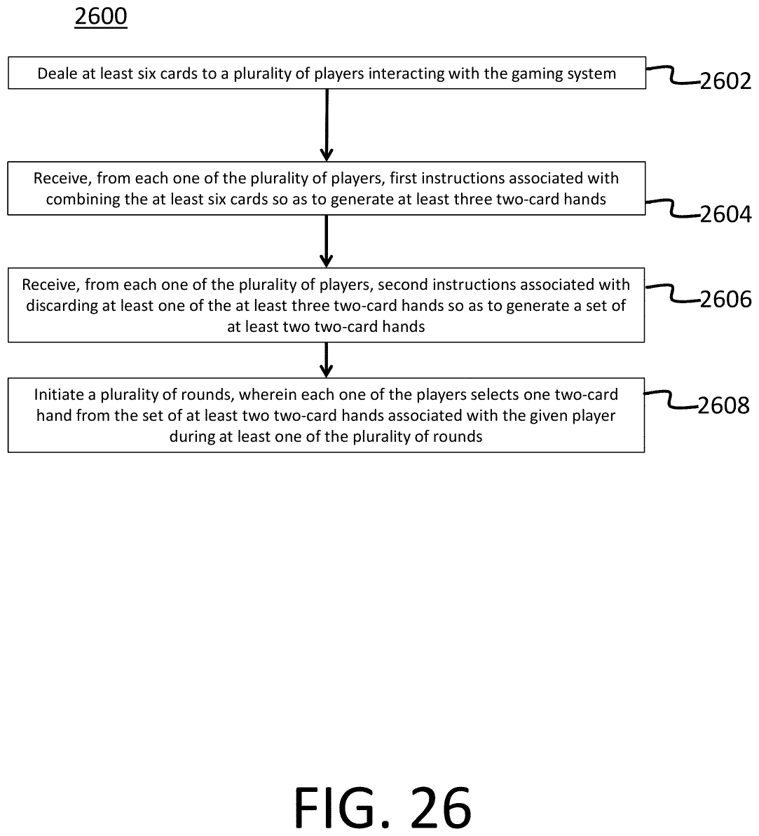

Turning now to FIG. 26, a flowchart illustrating a computer-implemented method 2600 of operating a gaming system is illustrated. In some embodiments, the computer-implemented method 2600 may be (completely or partially) implemented on a computing environment similar to the computing environment 100 and/or 200, such as, but not limited to an environment comprising a gaming server and gaming devices.

The method 2600 starts at a step 2602 by dealing at least six cards to a plurality of players interacting with the gaming system. Then, at a step 2604, the method 2600 executes receiving, from each one of the plurality of players, first instructions associated with combining the at least six cards so as to generate at least three two-card hands. Then, at a step 2606, the method 2600 executes receiving, from each one of the plurality of players, second instructions associated with discarding at least one of the at least three two-card hands so as to generate a set of at least two two-card hands. Then, at a step 2608, the method executes initiating a plurality of rounds, wherein each one of the players selects one two-card hand from the set of at least two two-card hands associated with the given player during at least one of the plurality of rounds.

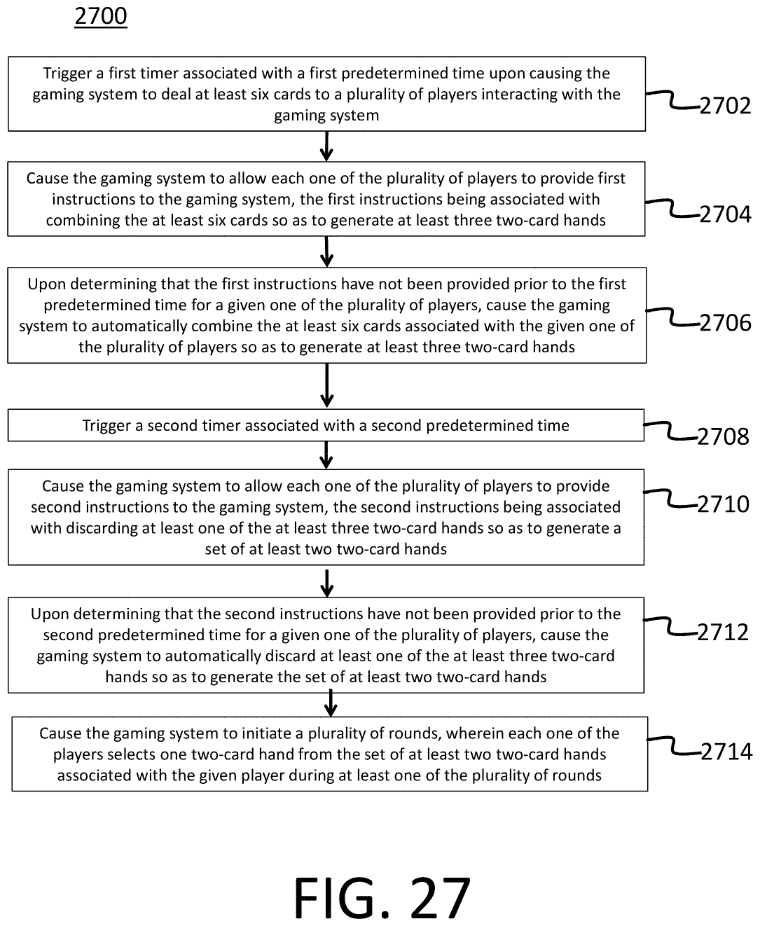

Turning now to FIG. 27, a flowchart illustrating a computer-implemented method 2700 of operating a gaming system is illustrated. In some embodiments, the computer-implemented method 2600 may be (completely or partially) implemented on a computing environment similar to the computing environment 100 and/or 200, such as, but not limited to an environment comprising a gaming server and gaming devices.

The method 2700 starts at a step 2702 by triggering a first timer associated with a first predetermined time upon causing the gaming system to deal at least six cards to a plurality of players interacting with the gaming system. Then, at a step 2704, the method executes causing the gaming system to allow each one of the plurality of players to provide first instructions to the gaming system, the first instructions being associated with combining the at least six cards so as to generate at least three two-card hands. At a step 2706, the method executes upon determining that the first instructions have not been provided prior to the first predetermined time for a given one of the plurality of players, causing the gaming system to automatically combine the at least six cards associated with the given one of the plurality of players so as to generate at least three two-card hands.

At a step 2708, the method executes triggering a second timer associated with a second predetermined time. Then, at a step 2710, the method executes causing the gaming system to allow each one of the plurality of players to provide second instructions to the gaming system, the second instructions being associated with discarding at least one of the at least three two-card hands so as to generate a set of at least two two-card hands. At a step 2712, the method executes upon determining that the second instructions have not been provided prior to the second predetermined time for a given one of the plurality of players, causing the gaming system to automatically discard at least one of the at least three two-card hands so as to generate the set of at least two two-card hands. At a step 2714, the method executes causing the gaming system to initiate a plurality of rounds, wherein each one of the players selects one two-card hand from the set of at least two two-card hands associated with the given player during at least one of the plurality of rounds.

In some embodiments, the card game is a Poker game.

In some embodiments, the method 2700 further comprises:

causing the gaming system to deal a first board of cards;

analyzing the selected one two-card hand of each one of the players and the first board of cards so as to determine which one of the players has a best combination of the selected one two-card hand and the first board of cards for the at least one of the plurality of rounds in accordance with Poker rules.

In some embodiments, the method 2700 further comprises:
removing the selected one two-card hand from the set of at least two two-card hands;
causing the gaming system to deal a second board of cards;
causing the gaming system to allow each one of the plurality of players to provide third instructions associated with selecting another two-card hand from the set of at least two two-card hands; and
analyzing the other selected one two-card hand of each one of the players and the second board of cards so as to determine which one of the players has another best combination of the selected other one two-card hand and the second board of cards in accordance with the Poker rules.

In some embodiments, the first instructions associated with the given one of the plurality of players are based on a selection of a first card and of a second card from the at least six cards.

In some embodiments, the second instructions associated with the given one of the plurality of players are based on a selection of at least one of the at least three two-card hands.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method of operating a gaming system, the method comprising:
causing the gaming system to deal at least six cards to a plurality of players interacting with the gaming system;
receiving, from each one of the plurality of players, first instructions associated with combining the at least six cards so as to generate at least three two-card hands;
receiving, from each one of the plurality of players, second instructions associated with discarding at least one of the at least three two-card hands so as to generate a set of at least two two-card hands; and
causing the gaming system to initiate a card game comprising a plurality of rounds, wherein each one of the players selects one two-card hand from the set of at least two two-card hands associated with the given player during at least one of the plurality of rounds.

2. The method of claim 1, wherein the card game is a Poker game.

3. The method of claim 2, further comprising:
causing the gaming system to deal a first board of cards; and
analyzing the selected one two-card hand of each one of the players and the first board of cards so as to determine which one of the players has a best combination of the selected one two-card hand and the first board of cards for the at least one of the plurality of rounds in accordance with Poker rules.

4. The method of claim 3, further comprising:
removing the selected one two-card hand from the set of at least two two-card hands;
causing the gaming system to deal a second board of cards;
receiving, from each one of the plurality of players, third instructions associated with selecting another two-card hand from the set of at least two two-card hands; and
analyzing the other selected one two-card hand of each one of the players and the second board of cards so as to determine which one of the players has another best combination of the selected other one two-card hand and the second board of cards in accordance with the Poker rules.

5. The method of claim 1, wherein the first instructions associated with the given one of the plurality of players are based on a selection of a first card and of a second card from the at least six cards.

6. The method of claim 1, wherein the second instructions associated with the given one of the plurality of players are based on a selection of at least one of the at least three two-card hands.

7. A method of operating a gaming system, the method comprising:
triggering a first timer associated with a first predetermined time upon causing the gaming system to deal at least six cards to a plurality of players interacting with the gaming system;
causing the gaming system to allow each one of the plurality of players to provide first instructions to the gaming system, the first instructions being associated with combining the at least six cards so as to generate at least three two-card hands;
upon determining that the first instructions have not been provided prior to the first predetermined time for a given one of the plurality of players, causing the gaming system to automatically combine the at least six cards associated with the given one of the plurality of players so as to generate at least three two-card hands;
triggering a second timer associated with a second predetermined time;
causing the gaming system to allow each one of the plurality of players to provide second instructions to the gaming system, the second instructions being associated with discarding at least one of the at least three two-card hands so as to generate a set of at least two two-card hands;
upon determining that the second instructions have not been provided prior to the second predetermined time for a given one of the plurality of players, causing the gaming system to automatically discard at least one of the at least three two-card hands so as to generate the set of at least two two-card hands; and
causing the gaming system to initiate a card game comprising a plurality of rounds, wherein each one of the players selects one two-card hand from the set of at least two two-card hands associated with the given player during at least one of the plurality of rounds.

8. The method of claim 7, wherein the card game is a Poker game.

9. The method of claim 8, further comprising:
causing the gaming system to deal a first board of cards;
analyzing the selected one two-card hand of each one of the players and the first board of cards so as to determine which one of the players has a best combination of the selected one two-card hand and the first board of cards for the at least one of the plurality of rounds in accordance with Poker rules.

10. The method of claim 9, further comprising:
removing the selected one two-card hand from the set of at least two two-card hands;
causing the gaming system to deal a second board of cards;
causing the gaming system to allow each one of the plurality of players to provide third instructions associated with selecting another two-card hand from the set of at least two two-card hands; and
analyzing the other selected one two-card hand of each one of the players and the second board of cards so as to determine which one of the players has another best combination of the selected other one two-card hand and the second board of cards in accordance with the Poker rules.

11. The method of claim 7, wherein the first instructions associated with the given one of the plurality of players are based on a selection of a first card and of a second card from the at least six cards.

12. The method of claim 7, wherein the second instructions associated with the given one of the plurality of players are based on a selection of at least one of the at least three two-card hands.

13. A gaming system, the gaming system comprising:
a processor;
a non-transitory computer-readable medium, the non-transitory computer-readable medium comprising control logic which, upon execution by the processor, causes:
triggering a first timer associated with a first predetermined time upon causing the gaming system to deal at least six cards to a plurality of players interacting with the gaming system;
causing the gaming system to allow each one of the plurality of players to provide first instructions to the gaming system, the first instructions being associated with combining the at least six cards so as to generate at least three two-card hands;
upon determining that the first instructions have not been provided prior to the first predetermined time for a given one of the plurality of players, causing the gaming system to automatically combine the at least six cards associated with the given one of the plurality of players so as to generate at least three two-card hands;
triggering a second timer associated with a second predetermined time;
causing the gaming system to allow each one of the plurality of players to provide second instructions to the gaming system, the second instructions being associated with discarding at least one of the at least three two-card hands so as to generate a set of at least two two-card hands;
upon determining that the second instructions have not been provided prior to the second predetermined time for a given one of the plurality of players, causing the gaming system to automatically discard at least one of the at least three two-card hands so as to generate the set of at least two two-card hands; and
causing the gaming system to initiate a card game comprising a plurality of rounds, wherein each one of the players selects one two-card hand from the set of at least two two-card hands associated with the given player during at least one of the plurality of rounds.
